(19) United States
(12) Patent Application Publication
(10) Pub. No.: US 2024/0230333 A1
(43) Pub. Date: Jul. 11, 2024

(54) METHOD FOR OPERATING A MICROELECTROMECHANICAL INERTIAL SENSOR AND SYSTEM FOR CARRYING OUT THE METHOD

(71) Applicant: Robert Bosch GmbH, Stuttgart (DE)

(72) Inventor: Michael Roelleke, Leonberg-Hoefingen (DE)

(21) Appl. No.: 18/494,204

(22) Filed: Oct. 25, 2023

(30) Foreign Application Priority Data
Jan. 10, 2023 (DE) 10 2023 200 105.5

(51) Int. Cl. G01C 19/5776

(52) U.S. Cl. CPC G01C 19/5776

(57) ABSTRACT

A method for operating a microelectromechanical inertial sensor, with which the microelectromechanical inertial sensor is designed to provide a measurement signal with respect to a measurement direction and at least one first transverse signal with respect to a first transverse direction that extends transversely to the measurement direction. In the method, a first crosstalk signal occurring due to a coupling between the measurement signal and the first transverse signal is filtered from the measurement signal, and a second crosstalk signal occurring due to the coupling is filtered from the first transverse signal. A correction signal is ascertained by fusing the filtered measurement signal and the filtered first transverse signal. The correction signal is fused with the measurement signal.

### CROSS REFERENCE

The present application claims the benefit under 35 U.S.C. § 119 of German Patent Application No. DE 10 2023 200 105.5 filed on Jan. 10, 2023, which is expressly incorporated herein by reference in its entirety.

### FIELD

The present invention relates to a method for operating a microelectromechanical inertial sensor and a system for carrying out the method.

### BACKGROUND INFORMATION

With microelectromechanical sensors (MEMS), which are designed to measure quantities such as accelerations and rotation rates, various deviations can occur in the measurement signal. These can be characterized by a specification, for example, but often cannot be compensated for in a measurement signal, since they cannot be directly assigned to a measurable variable. On the one hand, the underlying physical relationships may not be fully known, and on the other hand, there may be few ways to identify and characterize such variations in the measurement signal.

When using multi-axis MEMS sensors that are designed to provide measurement signals with respect to a plurality of mutually transverse directions, it is possible for measurement signals with respect to different directions to exhibit crosstalk, i.e., are coupled to one another and influence one another. In practice, a cross-sensitivity of such a MEMS sensor is typically specified. This is an indication in percent, which is to specify a total error in the measurement signal. This expresses how a signal is represented with respect to a transverse direction in a measurement signal.

### SUMMARY

One object of the present invention is to provide an improved method for operating a microelectromechanical inertial sensor and to provide an improved system for carrying out the method. This object may be achieved by a method for operating a microelectromechanical inertial sensor and a system for carrying out the method having features of the present invention. Advantageous developments and example embodiments of the present invention are disclosed herein.

According to an example embodiment of the present invention, a method for operating a microelectromechanical inertial sensor, with which the microelectromechanical inertial sensor is designed to provide a measurement signal with respect to a measurement direction and at least one first transverse signal with respect to a first transverse direction that extends transversely to the measurement direction, comprises the following method steps. A first crosstalk signal occurring due to a coupling between the measurement signal and the first transverse signal is filtered from the measurement signal, and a second crosstalk signal occurring due to the coupling is filtered from the first transverse signal. A correction signal is ascertained by fusing the filtered measurement signal and the filtered first transverse signal. The correction signal is fused with the measurement signal.

Advantageously, according to an example embodiment of the present invention, a corrected measurement signal, with which the first crosstalk signal is compensated for by fusing or linking or combining, as the case may be, the measurement signal with the correction signal, can be output. As a result, the measurement signal no longer has any components that can occur due to crosstalk between the two different measurement directions of the inertial sensor. In this way, a more reliable measurement signal can be provided.

In one example embodiment of the present invention, the microelectromechanical inertial sensor is designed to provide a second transverse signal with respect to a second transverse direction that extends transversely to the measurement direction and transversely to the first transverse direction. A crosstalk signal occurring due to a coupling between the measurement signal and/or the first transverse signal and/or the second transverse signal is ascertained in each case from the measurement signal, from the first transverse signal and from the second transverse signal. The correction signal is ascertained by fusing the filtered measurement signal, the filtered first transverse signal and the filtered second transverse signal. Advantageously, this can also provide a more reliable first transverse signal.

In one example embodiment of the present invention, the filtering of the crosstalk signals is performed in each case by means of a filter, which is designed either as a filter with a finite impulse response or as a filter with an infinite impulse response.

Digital filters are divided into the following two categories. A finite impulse response filter (FIR filter) and an infinite impulse response filter (IIR filter) are in each case discrete, usually digitally implemented filters and are used in the field of digital signal processing. A digital filter is an algorithm that uses a digital data set, such as the measurement signal and the transverse signals of the microelectromechanical inertial sensor, in order to extract information of interest and filter out unwanted information.

An FIR filter is defined by:

$$y ( n ) = {\sum }_{k = 0}^{N - 1} h ( k ) x ( n - k )$$

Here, y is an output signal and x is an input signal of the FIR filter. h is the so-called impulse response of the filter.

An IIR filter is defined by:

$$y ( n ) = {\sum }_{k = 0}^{∞} h ( k ) x ( n - k ) = {\sum }_{k = 0}^{q} {b}_{k} x ( n - k ) - {\sum }_{k = 1}^{p} {a}_{k} y ( n - k )$$

where a_{K} and b_{K} are filter coefficients.

FIR and IIR filters can offer different advantages and disadvantages. For example, an FIR filter is distinguished from an IIR filter by the fact that it has a linear phase response, which may be appropriate depending on the application.

In one example embodiment of the present invention, a transformation function is determined in each case for filtering the crosstalk signals from the measurement signal and the at least one first transverse signal. The transformation functions are determined on the basis of a channel model that models crosstalk due to the coupling between the measurement signal and the at least one first transverse signal.

Various channel models, which are used in the field of communication technology, for example, and which can be specifically designed depending on their use, are convention in the related art. In particular, separate models are formulated to describe different aspects of signal processing, such as noise and signal attenuation. In the present case, the different measurement directions can in each case be considered as one measurement channel. The crosstalk between the measurement channels is modeled in the channel model. In this case, real-world aspects in the structure of the microelectromechanical inertial sensor can be taken into account. For example, it can be taken into account that seismic mass elements of an acceleration sensor are suspended from a substrate in such a way as to cause a coupling between the seismic masses. Based on this model, the transformation functions of the filters are determined. A transformation function can also be called a transfer function. It describes a relationship between the input and output signals of the filter in frequency space.

In one example embodiment of the present invention, the following additional method step is carried out. The at least one first transverse signal is fused with the correction signal. Advantageously, this compensates for the second crosstalk signal in the first transverse signal. In addition, a third crosstalk signal in the second transverse signal can be compensated for by fusing the second transverse signal and the correction signal. Thus, in this embodiment, the correction signal is used to correct the measurement signal and the transverse signals. In other words, the same correction signal is used for each measurement direction of the microelectromechanical inertial sensor.

In one example embodiment of the present invention, the following additional method step is carried out. The at least one first transverse signal is fused with another correction signal based on the crosstalk signals. In addition, the third crosstalk signal in the second transverse signal can be compensated for by fusing the second transverse signal and an additional correction signal. In this embodiment, the correction signal is therefore only used to correct the measurement signal, while separate correction signals are in each case used for the first and second transverse signals.

In one example embodiment of the present invention, the filtered signals are weighted when ascertaining the correction signal. For example, by weighting the filtered signals when ascertaining the correction signal, different correction signals can be determined for the different measurement directions of the microelectromechanical inertial sensor. The weighting also makes it possible, for example, to neglect measurement directions. If necessary, technical features of the microelectromechanical inertial sensor can be taken into account in the weighting.

In one example embodiment of the present invention, a signal history of the measurement signal and/or the first transverse signal and/or the second transverse signal is taken into account when ascertaining the correction signal. Advantageously, known measurement artifacts of the microelectromechanical inertial sensor can be taken into account when ascertaining the correction signal.

In one example embodiment of the present invention, in each case a post-oscillation signal in the measurement signal and/or in the first transverse signal and/or in the second transverse signal is taken into account when ascertaining the correction signal. Vibrating or oscillating elements of the microelectromechanical inertial sensor exhibit post-oscillation behavior, i.e., an element concerned can perform an oscillation for a certain period of time, for example, after an acceleration has already acted on it. Such post-oscillation behavior can be recognized in the signal history and be advantageously taken into account when ascertaining the correction signal.

An example system for carrying out a method according to any of the example embodiments of the present invention comprises at least two filters and two fusion modules. The filters are designed to receive the measurement signal and the at least one first transverse signal and to filter the crosstalk signals from the measurement signal and the at least one first transverse signal. A first fusion module is designed to ascertain the correction signal by fusing the filtered measurement signal with the at least one filtered first transverse signal. A second fusion module is designed to fuse the correction signal with the measurement signal and to output a corrected measurement signal.

The method for operating a microelectromechanical inertial sensor and the system for carrying out the method according to example embodiments of the present invention are explained in more detail below in connection with figures.

### BRIEF DESCRIPTION OF THE DRAWINGS

FIG. 1 shows method steps of a method for operating a microelectromechanical inertial sensor, according to an example embodiment of the present invention.

FIG. 2 shows a system for carrying out the method of FIG. 1, according to an example embodiment of the present invention.

### DETAILED DESCRIPTION OF EXAMPLE EMBODIMENTS

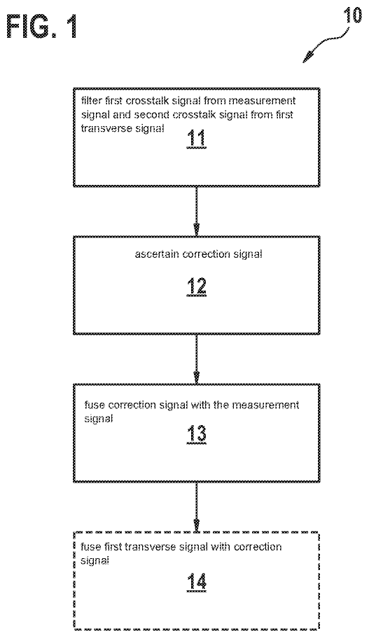

FIG. 1 schematically shows method steps 10, 11, 12, 13, 14 of a method 10 for operating a microelectromechanical inertial sensor. The microelectromechanical inertial sensor can be designed, for example, as an acceleration sensor or as a rotation rate sensor.

Microelectromechanical acceleration sensors and rotation rate sensors are conventional in the related art. They feature functional structures which are movably suspended from a substrate and can be created from semiconductor layers by texturing and exposing. These typically feature polycrystalline silicon and are deposited on the substrate. However, the semiconductor layers can also have a different material, such as a different semiconductor or a composite semiconductor. The substrate is typically designed as a silicon wafer, but this is not mandatory. Passivation and/or sacrificial layers are often arranged between the semiconductor layers, allowing the functional structures in the semiconductor layers to be textured and exposed. The functional structures can be, for example, seismic mass elements and associated spring elements, such as torsion springs.

The functional structures make it possible to measure a physical quantity, such as an acceleration, which acts on a moving functional structure. For example, a deflection of a mass element suspended from a spring element can be detected by arranging an electrode on the movably suspended mass element and a fixed electrode on the substrate to form an electrical capacitance. This changes with a distance between the electrodes. Such distance changes when the mass element is deflected as a result of an acceleration acting thereon. Thus, in this exemplary case, acceleration can occur in a direction perpendicular to the substrate. Furthermore, the microelectromechanical inertial sensor can also be designed, for example, to detect acceleration in a direction that extends in parallel with the substrate.

In general, the microelectromechanical inertial sensor is designed to provide a measurement signal with respect to a measurement direction and at least one first transverse signal with respect to a first transverse direction that extends transversely to the measurement direction. The first transverse direction is preferably designed to extend perpendicularly to the measurement direction, but can also be designed to extend obliquely to the measurement direction. Thus, the microelectromechanical inertial sensor is designed at least as a dual-axis sensor.

The measurement direction and the first transverse direction are never completely decoupled from one another and influence one another's signals. Thus, the measurement signal has a first crosstalk signal due to a coupling between the measurement signal and the first transverse signal. The first crosstalk signal modifies the measurement signal and represents a measurement error. Similarly, the first transverse signal has a second crosstalk signal due to the coupling.

The method 10 comprises a first method step 11 within the framework of which a first crosstalk signal is filtered from the measurement signal and a second crosstalk signal is filtered from the first transverse signal. The filtering of the crosstalk signals can, for example, be performed in each case by means of a filter that is designed either as a filter with a finite impulse response or as a filter with an infinite impulse response. The FIR filter and the IIR filter are digital filters. However, filtering of the crosstalk signals can also be performed by means of another filter. This also does not necessarily have to be a digital filter.

An FIR and an IIR filter are in each case based on the so-called transformation function. This can also be called a transition function or z-function. The transformation functions for the measurement signal and the first transverse signal can be determined, for example, by determining the transformation functions on the basis of a channel model that models crosstalk based on coupling between the measurement signal and the at least one first transverse signal.

In a second method step 12, a correction signal is ascertained by fusing the filtered measurement signal and the filtered first transverse signal. The filtered signals can be weighted when they are fused, but this is not mandatory. In addition, a signal history of the measurement signal and/or the first transverse signal can be taken into account. Thus, in addition to the crosstalk signals, other measurement artifacts can also be taken into account when ascertaining the correction signal. These can be specific to each microelectromechanical inertial sensor and identified in the signal histories of the measurement signal and the first transverse signal. For example, a post-oscillation behavior of the respective functional structures of the microelectromechanical inertial sensor can be taken into account.

In a third method step 13, the correction signal is fused with the measurement signal, which compensates for the first crosstalk signal in the measurement signal. In the simplest case, the measurement signal and the correction signal are added. However, the measurement signal and the correction signal can also be linked to one another in a different way.

Similarly, in an optional fourth method step 14, a fusion of the first transverse signal with the correction signal can be performed in order to compensate for the second crosstalk signal in the first transverse signal. In this case, the correction signal thus serves both to compensate for the first crosstalk signal in the measurement signal and to compensate for the second crosstalk signal in the first transverse signal. In an alternative embodiment, the first transverse signal can be fused with a further correction signal based on the crosstalk signals in order to compensate for the second crosstalk signal. For example, the further correction signal can differ from the correction signal in that they were in each case generated based on differently weighted filtered signals.

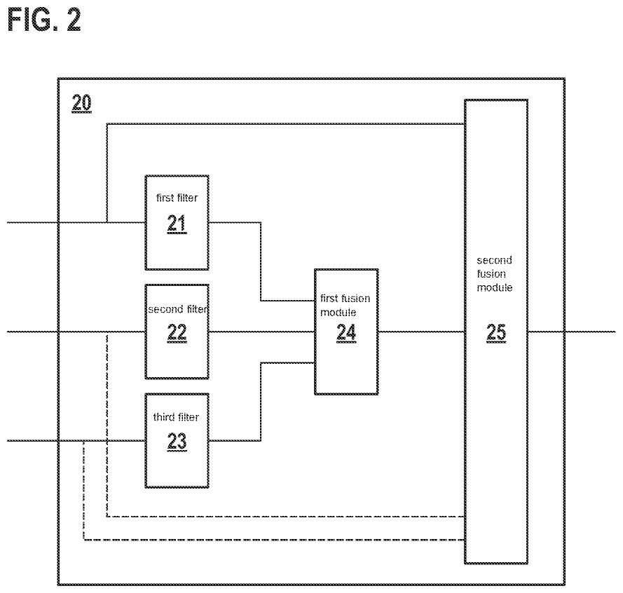

FIG. 2 shows schematically a system 20 for carrying out the method 10 of FIG. 1.

Exemplarily, the system 20 has three filters 21, 22, 23, but at least two filters 21, 22. The filters 21, 22, 23 are designed to receive the measurement signal and the at least one first transverse signal and to filter the crosstalk signals from the measurement signal and the at least one first transverse signal. A first filter 21 is designed to filter the first crosstalk signal from the measurement signal. A second filter 21 is designed to filter the second crosstalk signal from the first transverse signal.

Exemplarily, the system 20 of FIG. 2 is designed for a three-axis microelectromechanical inertial sensor. In this case, the microelectromechanical inertial sensor is designed to provide a second transverse signal with respect to a second transverse direction that extends transversely to the measurement direction and transversely to the first transverse direction. The second transverse direction can preferably be designed to extend perpendicularly to the measurement direction and perpendicularly to the first transverse direction.

In the first method step 10, a crosstalk signal occurring due to a coupling between the measurement signal and/or the first transverse signal and/or the second transverse signal is filtered in each case from the measurement signal, from the first transverse signal and from the second transverse signal, and in the second method step 12, the correction signal is ascertained by fusing the filtered measurement signal, the filtered first transverse signal and the filtered second transverse signal. The filtered signals can be weighted when they are fused, but this is not mandatory. In addition, a signal history, such as a post-oscillation behavior of the measurement signal and/or the first transverse signal, can be taken into account.

Based on the additional second crosstalk signal that the microelectromechanical inertial sensor can provide, the system 20 has a third filter 23 that is designed to filter a third crosstalk signal from the second crosstalk signal. The filters 21, 22, 23 can in each case be designed as FIR and/or IIR filters. In the case of a dual-axis microelectromechanical inertial sensor, the third filter can be omitted.

The system 20 also has two fusion modules 24, 25. A first fusion module 24 is connected to the filters 21, 22, 23 and is designed to receive filtered signals from the filters 21, 22, 23, to ascertain the correction signal or a plurality of correction signals, such as one correction signal each for the measurement direction and the transverse directions, by fusing the filtered measurement signal with the at least one filtered first transverse signal, and to provide the at least one correction signal to a second functional module 25.

The second fusion module 25 is connected to the first functional module 24 and is designed to receive and fuse the at least one correction signal with the measurement signal and to output a corrected measurement signal. The second fusion module 25 can also optionally be designed to fuse the first transverse signal with the correction signal in order to compensate for the second crosstalk signal in the first transverse signal. Alternatively, the second fusion module 25 can be designed to fuse the first crosstalk signal with the further correction signal based on the crosstalk signals, in order to compensate for the second crosstalk signal. Alternatively or additionally, the second fusion module 25 can also be designed to fuse the second transverse signal with the correction signal, the further correction signal or an additional correction signal, in order to compensate for the third crosstalk signal in the second transverse signal.

What is claimed is:

1. A method for operating a microelectromechanical inertial sensor, wherein the microelectromechanical inertial sensor is configured to provide a measurement signal with respect to a measurement direction and at least one first transverse signal with respect to a first transverse direction that extends transversely to the measurement direction, the method comprising the following method steps:
filtering a first crosstalk signal occurring due to a coupling between the measurement signal and the first transverse signal from the measurement signal and a second crosstalk signal occurring due to a coupling from the first transverse signal;
ascertaining a correction signal by fusing the filtered measurement signal and the filtered first transverse signal;
fusing the correction signal with the measurement signal.

2. The method according to claim 1, wherein the microelectromechanical inertial sensor is configured to provide a second transverse signal with respect to a second transverse direction that extends transversely to the measurement direction and transversely to the first transverse direction, wherein a crosstalk signal occurring due to a coupling between the measurement signal and/or the first transverse signal and/or the second transverse signal is filtered in each case from the measurement signal, from the first transverse signal, and from the second transverse signal, and wherein the correction signal is ascertained by fusing the filtered measurement signal, the filtered first transverse signal, and the filtered second transverse signal.

3. The method according to claim 1, wherein the filtering of the first and second crosstalk signals is performed in each case using a filter that is configured as a filter with a finite impulse response or as a filter with an infinite impulse response.

4. The method according to claim 3, wherein a transformation function is determined in each case for filtering the first and second crosstalk signals from the measurement signal and the at least one first transverse signal, wherein the transformation functions are determined based on a channel model that models crosstalk due to the coupling between the measurement signal and the at least one first transverse signal.

5. The method according to claim 1, further comprising:
fusing the at least one first transverse signal with the correction signal.

6. The method according to claim 1, further comprising:
fusing the at least one first crosstalk signal with a further correction signal based on the first and second crosstalk signals.

7. The method according to claim 1, wherein the filtered measurement signal and the filtered first transverse signal are weighted when ascertaining the correction signal.

8. The method according to claim 2, wherein a signal history of the measurement signal and/or the first transverse signal and/or a second transverse signal is taken into account when ascertaining the correction signal.

9. The method according to claim 8, wherein in each case, a post-oscillation signal in the measurement signal and/or in the first transverse signal and/or in the second transverse signal is taken into account when ascertaining the correction signal.

10. The method according to claim 1, wherein the microelectromechanical inertial sensor is an acceleration sensor or a rotation rate sensor.

11. A system for operating a microelectromechanical inertial sensor, wherein the microelectromechanical inertial sensor is configured to provide a measurement signal with respect to a measurement direction and at least one first transverse signal with respect to a first transverse direction that extends transversely to the measurement direction, the system comprising:
at least two filters and two fusion modules, wherein the filters are configured to receive the measurement signal and the at least one first transverse signal and to filter crosstalk signals from the measurement signal and the at least one first transverse signal;
wherein a first fusion module of the fusion modules is configured to ascertain the correction signal by fusing measurement signal unfiltered with the at least one filtered first transverse signal, wherein a second fusion module of the fusion modules is configured to fuse the correction signal with the measurement signal and to output a corrected measurement signal.
